(19) United States
(12) Patent Application Publication
(10) Pub. No.: US 2011/0035610 A1
(43) Pub. Date: Feb. 10, 2011

(54) ENERGY SAVING METHOD AND SYSTEM

(76) Inventors: Mark Stuart, Buckinghamshire (GB); Richard Marsh, Buckinghamshire (GB); Shane Wilson, Buckinghamshire (GB); Milton Mukhopadhyay, Buckinghamshire (GB)

Correspondence Address: WELSH FLAXMAN & GITLER LLC, 2000 DUKE STREET, SUITE 100, ALEXANDRIA, VA, 22314, US

(21) Appl. No.: 12/793,298

(22) Filed: Jun. 3, 2010

(30) Foreign Application Priority Data
Aug. 6, 2009 (EP) 09167394.7

(51) Int. Cl. G06F 1/26; G06F 15/173; G06F 1/32

(52) U.S. Cl. 713/310; 709/224; 713/320

(57) ABSTRACT

A method for controlling the power consumption in a peer-to-peer (P2P) network of content delivery devices is provided. The method comprises the steps of: determining the capacity of the network to deliver each content unit stored on a device; determining the demand of the network for each content unit stored on the device; comparing the capacity with the demand for each content unit stored on the device; and controlling the power supplied to said device based on said comparison.

The present invention generally relates to television and media distribution networks. In particular, the present invention relates to a method and system for reducing energy consumption within a distribution network of cooperating peer devices or Peer-to-Peer (P2P) distribution networks.

Distribution of radio and television (TV) programmes, movies, music, ring tones, games, and various data applications to the general public is achieved today via a variety of dedicated networks and end user terminals. With the proliferation of broadband Internet, all content distribution services are increasingly conveyed to the general public via the Internet.

As broadband Internet becomes ubiquitous, there has been a substantial growth in demand for Internet television. However, the current infrastructure of the Internet is not suited to simultaneous transmission of live events to millions of people (i.e. broadcasting). The problem is that such transmissions require a dedicated stream of data to be sent to every single user. With millions of potential users, the simultaneous streams of data quickly congest the Internet.

For several years, this problem has been addressed by multicasting, whereby the data stream is distributed to many local servers that subsequently “re-broadcast” the content to local users. However, most Internet Protocol (IP) routers cannot support multicasting and there seems to be no financial incentive for the Internet service providers to introduce multicasting. Furthermore, the use of audiovisual media is moving from a collective and passive approach to personal active behaviour, at home and in mobile situations outside the home. At the same time, patterns are shifting towards non-linear usages, moving away from the classic model of linear broadcast TV. The TV set no longer has the monopoly of delivery of audiovisual content, with the personal computer (PC) and related media centres such as personal digital assistants (PDAs) and mobile phones, all becoming increasingly important.

In such heterogeneous environments, efficient content delivery needs optimised unicast, multicast and broadcast delivery, as well as support for new mechanisms that have been made possible by the recent advances in P2P-based technology. This situation has important consequences for the existing business models and institutions, as well as for content production, content distribution, and end user experience on various terminals. This holds in particular for organisations that propose services based on heterogeneous terminals and networks, given the demand from users of transparent service continuity.

To address these needs, P2P technology can be used to provide efficient and low-cost delivery of professional and user created content. Although P2P technology is not traditional content delivery/distribution (CDN) technology, it is extensively used to deliver content to end users, being considered by many as an efficient mechanism for distributing any media file or live stream. Accordingly, it has been recognised that the emerging P2P technology may be used to provide an open source, efficient, and participatory television plus media delivery mechanism with social and collaborative connotation.

However, the proposal for P2P television plus media distribution has raised concerns about the oversupply of content which may lead to gross inefficiency in the network operation. This is because many devices in such P2P networks would need to be left in a high-power state in case the content they are sharing is needed by other peers.

The present invention is directed towards reducing the overall energy consumption in P2P networks used to distribute television and media via the Internet in order to improve their overall efficiency and minimise costs.

According to the present invention there is provided a method for controlling the power consumption in a peer-to-peer network of content delivery devices wherein at least one device stores at least one content unit, the method comprising the steps of:
determining the capacity of the network to deliver each content unit stored on a device;
determining the demand of the network for each content unit stored on said device;
comparing the capacity with the demand for each content unit stored on said device; and
controlling the power supplied to said device based on said comparison.
Furthermore, according to the present invention there is also provided a system for controlling the power consumption in a peer-to-peer network of content delivery devices wherein at least one device stores at least one content unit, the system comprising:
means for determining the capacity of the network to deliver each content unit stored on a device;
means for determining the demand of the network for each content unit stored on said device;
means for comparing the capacity with the demand for each content unit stored on said device; and
means for controlling the power supplied to said device based on said comparison.

Accordingly, it is possible to reduce the overall energy consumption in a P2P network by evaluating the supply capability of a community of peers for a given piece of content.

The present invention will now be described with reference to the accompanying drawings, in which:

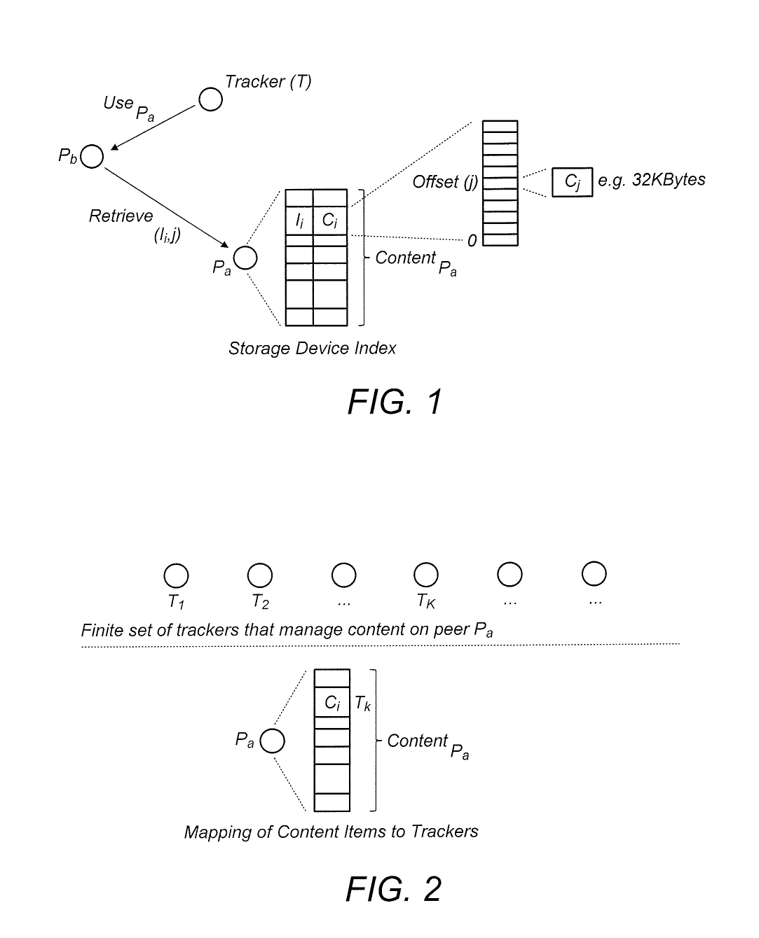

FIG. 1 is a schematic representation of the interactions between the different elements of a P2P network;

FIG. 2 is a schematic representation of mapping content items via a plurality of trackers in a system according to the present invention;

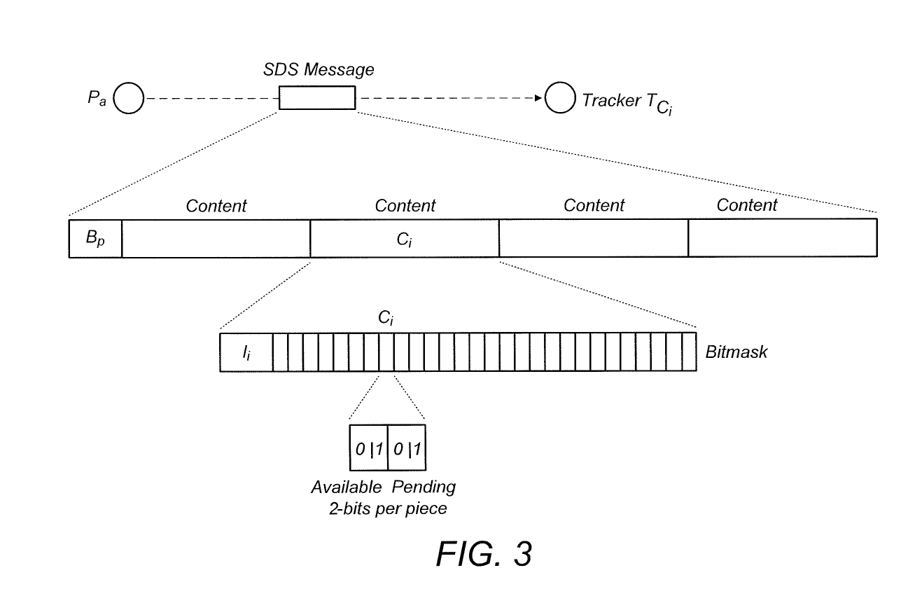

FIG. 3 is a schematic representation of possible supply and demand status (SDS) messages in a system according to the present invention;

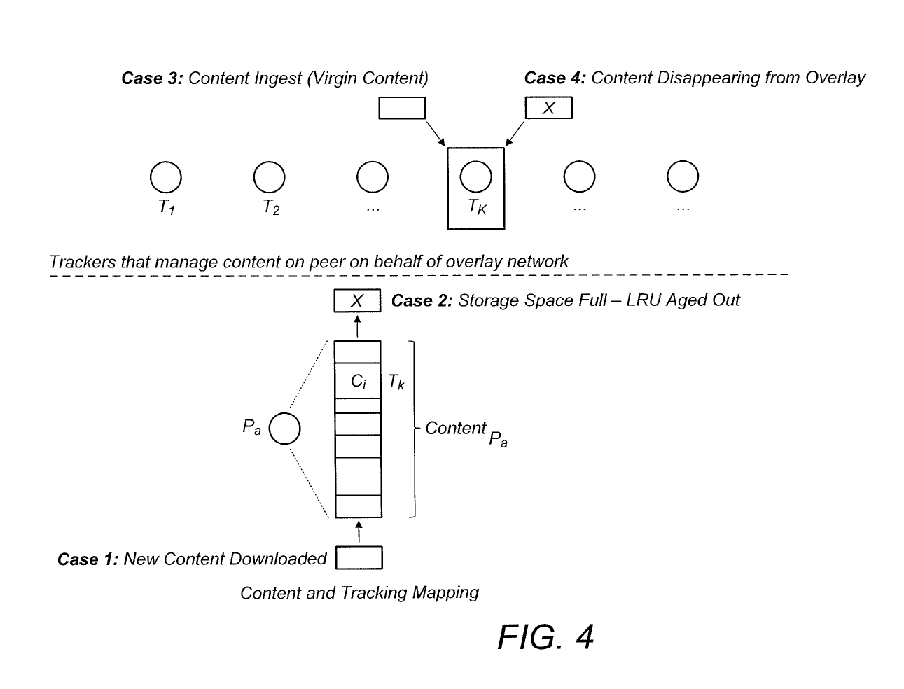

FIG. 4 is a schematic representation of four scenarios possible when employing the method according to the present invention.

FIG. 1 shows the interactions between the different elements of a P2P network. A peer device (hereafter referred to as a peer) Pₐ in the network is provided with a content storage device and makes available to the network a discrete set of content items Content_{Pa}, which it has previously acquired or is in the process of acquiring from the network:

Content_{Pa}={C₁, C₂, . . . , Cₙ}

A tracker T is used as a means for tracking the content item Cᵢ. Content item Cᵢ is identified by an infohash which is unique within the context of the tracker T that is used to track content item Cᵢ. Each content item Cᵢ is divided into content pieces cⱼ, which, at any given time, a peer Pₐ sharing that content may possess all or a just a subset of:

Cᵢ={c₁, c₂, . . . , cₙ}

Content pieces c_{i,j} can be unambiguously identified within the network by the combination (Iᵢ, j) of an infohash I, and a content piece offset j from byte 0 of the content item Cᵢ. A typical content piece size is in the region of 32 KBytes to 1 MByte. As will be explained below, content pieces cⱼ are considered the management unit in the method according to the present invention.

In FIG. 1, a peer Pₐ shares a set of content items Content_{Pa} with the network. Pₐ provides content pieces cⱼ in response to requests by another peer P_{b} which discovered via a tracker T that Pₐ has pieces of the desired content available for download. The tracker T maintains mappings between content and peers within the network. For each content item Cᵢ a peer P_{b} is interested in obtaining, the peer P_{b} queries the tracker T hosting the content item Cᵢ asking which peers it should connect to in order to obtain the content pieces cⱼ it is missing. It will be appreciated that more than one tracker T are usually used in a P2P network. As will be explained below, the trackers T in a system according to the present invention represent means for providing information about both supply and demand for pieces of content c_{i,j.}

FIG. 2 is a schematic representation of mapping content items via a plurality of trackers in a system according to the present invention. Each peer Pₐ has a relationship to a set of tracking devices:

Trackers_{Pa}={T₁, T₂, . . . , Tₖ}

Trackers are the means by which peers both advertise the content pieces they are storing, and discover peers that can supply the content they are interested in acquiring. There can be a one-to-many relationship between any given content piece stored by a peer Pₐ and the trackers advertising its availability to share that content piece. Each content piece in the set Content_{Pa} is managed by one or more trackers.

As soon as a peer Pₐ is brought “online” (i.e. within the network), it advertises to its related trackers (Trackers_{Pa}) the content pieces it possesses and then asks all those trackers to vote on whether it should power down due to oversupply. As a mediator for access to content pieces by the peer community they serve, any given tracker Tₖ managing a content piece c_{i,j} is able to determine two key measures: the demand D_{i,j} for content piece c_{i,j} and the supply S_{i,j} for content piece c_{i,j.}

The supply S_{i,j} for a content piece c_{i,j} is calculated by each associated tracker Tₖ as the sum of the available bandwidth B across all peers that are able to share content piece c_{i,j} and it is expressed in units of bytes per second (bps).

$${S}_{i , j} = {\sum }_{P} {B}_{P}$$

Due to the expected variation in supply of available bandwidth for any given peer, measurements of B are reported to all of the peer's related trackers as an exponential moving average:

Bₜ=αBₜ₋₁+(1−α)B_{observed}

, wherein α is a smoothing factor that can be determined through empirical research within the network.

The available bandwidth capacity B and the content piece availability are reported to every tracker Tₖ that the peer connects to Pₐ via supply and demand status (SDS) messages. Trackers are contacted intermittently by the community of peers they oversee and informed of the content that the peers possess. The content is identified as a combination of the infohash (e.g. based on a content identifier such as a torrent file) and a bitmask that details which content pieces the peer has successfully acquired and is able to share with other peers. The combination of the infohash values, bitmasks, and bandwidth availability figures so reported are the audit information maintained by the tracker Tₖ. It is this information that enables tracker Tₖ to fulfil its role in an energy management system according to the present invention.

FIG. 3 schematically shows a possible format of a SDS message sent from a peer Pₐ to a tracker T_{Ci}. The SDS message contains supply and demand information for the array of content items Cᵢ chosen by the peer Pₐ to be managed by the tracker T_{Ci} Each content item Cᵢ is identified by its infohash Iᵢ and has a bitmask outlining both the content piece availability and pending status. A pending status of 1 indicates that the content piece was requested by Pₐ, but that the request was unfulfilled in the time period in which the SDS message was compiled.

In the event that multiple trackers have knowledge of the content, for any given content piece c_{i,j} in a system according to the present invention, a peer Pₐ holding that content must decide which tracker T_{Ci}; to notify of changing supply and demand status. Every content item Cᵢ maps to a single tracker T_{Ci}; with respect to SDS messaging. It is important to note that the peer Pₐ shall only update T_{Ci}; with the supply and demand metrics, but it may locate peers for sharing purposes from as many trackers as it knows maintain information for the content pieces of Cᵢ. Accordingly, the system's load balancing and robustness are maintained.

The demand D_{i,j} for a piece c_{i,j} over an n second period can be calculated as:

$${D}_{i , j} = \frac{( {\sum }_{t = 1}^{n} downloads ( t , {c}_{i , j} ) ) \cdot size ( {c}_{i , j} )}{n} + \frac{( {\sum }_{t = 1}^{n} pending ( t , {c}_{i , j} ) ) \cdot size ( {c}_{i , j} )}{n}$$

, where downloads(t, c_{i,j}) represents the number of downloads of c_{i,j} in the period {t−1, t} seconds and size(c_{i,j}) is the size of c_{i,j} measured in bytes. A tracker T_{Ci}, can calculate this as a delta with respect to the number of peers under its coverage that maintain a copy of the content piece for sharing, thereby having successfully acquired the content piece during that time period. The function pending(t, c_{i,j}) corresponds to the number of unfulfilled requests made for c_{i,j} in the sampling period [t−1, t]. In the case of oversupply within the network, it is expected that pending(t, c_{i,j}) be equal to zero.

The tracker T_{Ci} calculates an exponential moving average for D_{i,j} as follows:

Dₜ=αDₜ₋₁+(1−α)D_{observed}

, where α is a smoothing factor that can be determined through empirical research during the operation of the network.

When a peer Pₐ wants to know whether it should enter a low-power state to preserve energy and thereby optimise efficiency of the network as a whole, it contacts all of the trackers to which it has a connection by sending an ENERGYSAVE_INQUIRY message. During the course of receiving SDS messages, a tracker T_{Ci}; will have calculated D_{i,j} and S_{i,j} for all content pieces c_{i,j} reported by peers. In the cases where D_{i,j}>0, the tracker T_{Ci}; evaluates the following health function H_{i,j}=S_{i,j}/D_{i,j.}

If H_{i,j} is above a threshold γ for all content pieces c_{i,j} being shared by the peer Pₐ and for which the tracker T_{Ci}, is advertising availability, the tracker T_{Ci} votes YES in response to the peer's ENERGYSAVE_INQUIRY. It is expected that γ may be a value between 2 and 5 (representing 200%-500% oversupply). However, in practice, γ will depend on the underlying network topology and hence may be a tuneable parameter affecting the system's operation. Furthermore, γ may need to be optimised through a process of empirical study and operational research, details of which are beyond the scope of this invention.

If all the trackers that a peer Pₐ connects to vote YES in response to the ENERGYSAVE_INQUIRY, then the peer Pₐ may either power down, or it may stop sharing content pieces, entering a low-power state until further notice or for a time period Δ_{pd}. Δ_{pd} can be determined as a function of the network operation and also serves as a tuneable parameter under the control of tracker administrators. The peer Pₐ may reawaken and resume normal sharing behaviour upon receipt of a SHARE_REQUEST message from one or more of the trackers Tₖ it relates to. This message may be received by the peer Pₐ due to the tracker Tₖ becoming aware of an undersupply within the network. The tracker Tₖ may select the peer Pₐ for reawakening based on its average upload availability and therefore its anticipated ability to plug the bandwidth gap between supply and demand.

It will be appreciated that when an end-user is actively using a peer device e.g. watching TV recordings, then the device may not enter a low-power or power down state independently. The method according to the present invention primarily relates to peers in an idle state.

FIG. 4 is a schematic representation of four scenarios or cases possible when employing the method according to the present invention.

Case 1 illustrates the scenario when new content enters the pool of shared content pieces by being selected and downloaded by the user of the peer device Pₐ. Because finite storage capacity is assumed for a peer Pₐ, aged content can be moved out of storage according to a heuristic method such as Least Recently Used (LRU) to make space for new content (Case 2). Case 3 represents a situation when a peer Pₐ ingests content that has never been witnessed before on the overlay network (e.g. new user generated content during a live event). Eventually, certain content becomes so unpopular that it is retired from the network when the last peer Pₐ maintaining a copy of it deletes it (Case 4). The four scenarios are described below.

Case 1: The peer Pₐ discovers new content C_{new} and starts to download and share it. In this case, the peer Pₐ is acquiring content that has been seeded within the network beforehand. The peer Pₐ engages in the process of peer tracking and downloads content pieces from a variety of different peers. Intermittently, the peer Pₐ updates a random or otherwise selected tracker Tₖ it is connected to. SDS messages provide details of the content pieces the peer Pₐ possesses in order to perform auditing and energy management.

Case 2: Pₐ's storage capacity is exhausted (for example due to C_{new}) thus rendering pieces of content C_{aged} to become aged. When a peer Pₐ no longer has C_{aged} available for sharing because it has been deleted from its storage area, Pₐ notifies the associated trackers which, in turn, delete the auditing information for the associated content pieces of C_{aged} they are maintaining.

Case 3: Content C_{virgin} is ingested by a peer Pₐ into the network for the first time ever. New content C_{virgin} entering the network via a given tracker Tₖ has demand strength assigned to its content pieces as follows:

D_{i,j virgin}=0

Its supply strength is simply the bandwidth Bₐ reported by Pₐ:

S_{i,j virgin}=Bₐ

Case 4: Content C_{gone} leaves the network because it is deleted from the last peer Pₐ storing it. In this case, the trackers maintaining information for the pieces of C_{gone} delete all traces of the maintained audit information for the pieces of C_{gone}.

When a peer Pₐ first connects to the network, it must bootstrap itself. The peer Pₐ starts out without no content pieces to share and all of its uploading capacity is available. The peer Pₐ determines the bandwidth it can use for upload by uploading to a publicly available speedtest server a test file designed for this purpose. This figure is recorded as B₀ and reported to the trackers in a similar manner to new content being downloaded (in Case 1).

It will be appreciated that because the method according to the present invention does not require a central authority or database, it is deemed to be scalable and flexible for a number of different geographic and/or structural implementations. The granularity of tracker management functionality may be global, regional, broken down according to peer density or allocated according to social grouping prevalent between the users of peer devices (e.g. group of friends or affinity groups).

1. A method for controlling the power consumption in a peer-to-peer network of content delivery devices wherein at least one device stores at least one content unit, the method comprising the steps of:
determining the capacity of the network to deliver each content unit stored on a device;
determining the demand of the network for each content unit stored on said device;
comparing the capacity with the demand for each content unit stored on said device; and
controlling the power supplied to said device based on said comparison.

2. A method according to claim 1, wherein comparing the capacity with the demand comprises calculating the ratio of the capacity to the demand.

3. A method according to claim 2, wherein controlling the power comprises reducing the power supplied to said device if the ratio is above a predetermined threshold.

4. A method according to claim 1, wherein the at least one device includes plural devices and each device has a bandwidth and determining the capacity of the network to deliver a content unit comprises calculating the total bandwidth across all devices storing the content unit.

5. A method according to claim 1, wherein the at least one device includes plural devices and each device is configured, in use, to download a content unit from a device storing the content unit and determining the demand of the network for a content unit comprises calculating the total number of downloads of the content unit across all devices.

6. A method according to claim 4, wherein the total bandwidth is calculated as an exponential moving average.

7. A method according to claim 5, wherein the total number of downloads is calculated as an exponential moving average.

8. A system for controlling the power consumption in a peer-to-peer network of content delivery devices wherein at least one device stores at least one content unit, the system comprising:
means for determining the capacity of the network to deliver each content unit stored on a device;
means for determining the demand of the network for each content unit stored on said device;
means for comparing the capacity with the demand for each content unit stored on said device; and
means for controlling the power supplied to said device based on said comparison.
